(19) United States
(12) Patent Application Publication
(10) Pub. No.: US 2025/0014248 A1
(43) Pub. Date: Jan. 9, 2025

(54) IMAGE PROCESSING APPARATUS, IMAGE PROCESSING METHOD, AND PROGRAM

(71) Applicant: SONY GROUP CORPORATION, TOKYO (JP)

(72) Inventor: YUYA YAMASHITA, TOKYO (JP)

(21) Appl. No.: 18/713,210

(22) PCT Filed: Nov. 17, 2022
(86) PCT No.: PCT/JP2022/042662

§ 371 Date: May 24, 2024

(30) Foreign Application Priority Data
Dec. 1, 2021 (JP) 2021-195415

(51) Int. Cl. G06T 11/60; G06V 10/60; G06V 10/82; H04N 1/60

(52) U.S. Cl. CPC G06T 11/60; G06V 10/60; G06V 10/82; H04N 1/60

(57) ABSTRACT

The present disclosure relates to an image processing apparatus, an image processing method, and a program that enables enhancement of the accuracy of correction of captured images. An image processing apparatus is provided, and the image processing apparatus includes a processing unit that corrects a captured image for each first unit, estimates a parameter for correction of the captured image on the basis of a relationship between the captured image and an intermediate corrected image obtained by correction for each first unit, and corrects the captured image for each second unit larger than each first unit, using the estimated parameter. The present disclosure can be applied to a cloud server that provides services via the Internet, for example.

### TECHNICAL FIELD

The present disclosure relates to an image processing apparatus, an image processing method, and a program, and more particularly, to an image processing apparatus, an image processing method, and a program that enable enhancement of accuracy of captured image correction.

### BACKGROUND ART

Programs having a function of automatically editing a captured image such as a still image or a moving image captured by a user have been provided. For example, Patent Document 1 discloses a program for designating a template as a program for automatically editing a moving image.

### CITATION LIST

### Patent Document

Patent Document 1: Japanese Patent Application Laid-Open No. 2009-55152

### SUMMARY OF THE INVENTION

### Problems to be Solved by the Invention

In providing a moving image production service for editing captured images to create a moving image, there are cases where a correction process is performed on captured images, and it is required to increase the accuracy of correction of the captured images.

The present disclosure has been made in view of such circumstances, and is to enable enhancement of captured image correction.

### Solutions to Problems

An image processing apparatus according to one aspect of the present disclosure is an image processing apparatus including a processing unit that corrects a captured image for each first unit, estimates a parameter for correction of the captured image on the basis of a relationship between the captured image and an intermediate corrected image obtained by correction for each first unit, and corrects the captured image for each second unit larger than each first unit, using the estimated parameter.

An image processing method according to one aspect of the present disclosure is an image processing method including: by an image processing apparatus, correcting a captured image for each first unit; estimating a parameter for correction of the captured image, on the basis of a relationship between the captured image and an intermediate corrected image obtained by correction for each first unit; and correcting the captured image for each second unit larger than each first unit, using the estimated parameter.

A program according to one aspect of the present disclosure is a program for causing a computer to function as a processing unit that corrects a captured image for each first unit, estimates a parameter for correction of the captured image on the basis of a relationship between the captured image and an intermediate corrected image obtained by correction for each first unit, and corrects the captured image for each second unit larger than each first unit, using the estimated parameter.

In an image processing apparatus, an image processing method, and a program according to one aspect of the present disclosure, a captured image is corrected for each first unit, a parameter for correction of the captured image is estimated on the basis of a relationship between the captured image and an intermediate corrected image obtained by correction for each first unit, and the captured image is corrected with the estimated parameter for each second unit larger than each first unit.

Note that an image processing apparatus according to one aspect of the present disclosure may be an independent apparatus or an internal block forming one apparatus.

### BRIEF DESCRIPTION OF DRAWINGS

FIG. 1 is a diagram illustrating an example configuration of an embodiment of a moving image production system to which the present disclosure is applied.

FIG. 2 is a block diagram illustrating an example configuration of a camera.

FIG. 3 is a block diagram showing an example configuration of a cloud server.

FIG. 4 is a block diagram illustrating an example configuration of a terminal device.

FIG. 5 is a diagram illustrating an overall flow indicating the flow in a moving image production service.

FIG. 6 is a diagram illustrating an example of a moving image production algorithm.

FIG. 7 is a diagram illustrating an example of a correction process to be performed in automatic quality correction.

FIG. 8 is a block diagram illustrating an example of the functional configuration of a processing unit in the cloud server.

FIG. 9 is a diagram illustrating an outline of a first example of a correction process.

FIG. 10 is a diagram illustrating an example of a correction algorithm using a trained model.

FIG. 11 is graphs showing an example of edit parameters.

FIG. 12 is a diagram illustrating an example of an image that is processed in the first example of a correction process.

FIG. 13 is a flowchart for explaining the flow in the first example of a correction process.

FIG. 14 is a diagram illustrating an outline of a second example of a correction process.

FIG. 15 is a table showing an example of parameters for brightness and contrast.

FIG. 16 is graphs showing an example of parameters for brightness and contrast.

FIG. 17 is a diagram illustrating an outline of a second example of a correction process.

FIG. 18 is a flowchart for explaining the flow in the second example of a correction process.

FIG. 19 is a diagram illustrating another example configuration of the processing unit that performs the second example of a correction process.

FIG. 20 is a flowchart for explaining the flow in the second example of a correction process to be performed by the processing unit illustrated in FIG. 19.

### MODE FOR CARRYING OUT THE INVENTION

### <Example System Configuration>

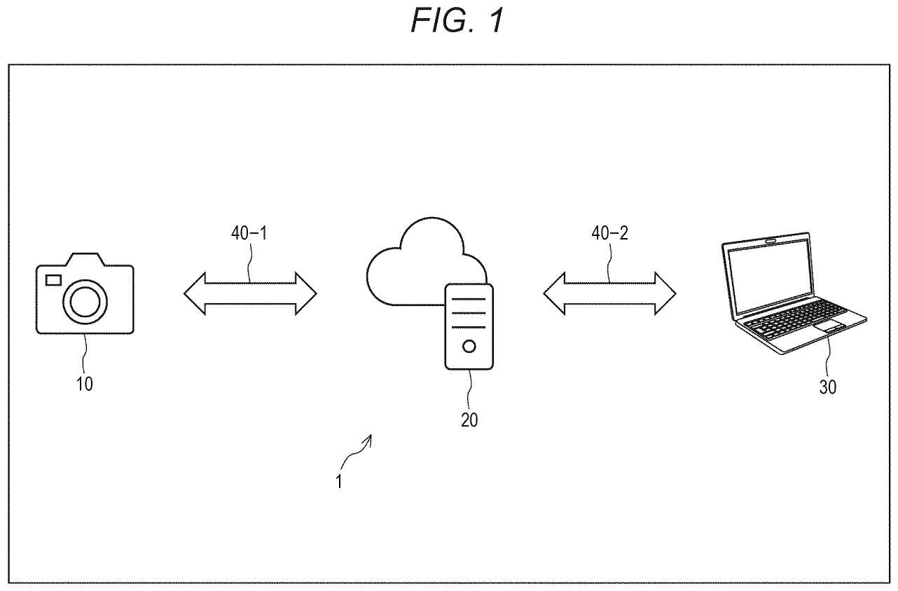

FIG. 1 is a diagram illustrating an example configuration of an embodiment of a moving image production system to which the present disclosure is applied.

A moving image production system 1 in FIG. 1 is a system that produces a moving image from an image captured by a user. The moving image production system 1 includes a camera 10, a cloud server 20, and a terminal device 30.

The camera 10 is a digital camera capable of capturing moving images and still images. The camera 10 is not necessarily a digital camera, and may be a device having an imaging function, such as a smartphone or a tablet terminal. The camera 10 captures an image of the object in accordance with a user's operation, and records the captured image obtained as a result.

The captured image includes a moving image and a still image. In the description below, in a case where it is necessary to distinguish between a moving image as a captured image and a moving image automatically produced by a moving image production service, the latter will be referred to as a produced moving image.

The image captured by the camera 10 is transmitted to the cloud server 20. The camera 10 can transmit the captured image to the cloud server 20 via a network 40-1. Alternatively, the terminal device 30 may transmit the captured image to the cloud server 20 via a network 40-2 by transferring the captured image from the camera 10 to the terminal device 30, using a memory card such as a flash memory, wireless communication such as a wireless local area network (LAN), or the like.

The network 40-1 and the network 40-2 include communication lines of the Internet, a mobile telephone network, or the like. The network 40-1 and the network 40-2 may be the same network, or may be different networks. Hereinafter, in a case where the network 40-1 and the network 40-2 do not need to be distinguished from each other, they will be referred to as the network 40.

The cloud server 20 is a server that provides a moving image production service for producing (automatically producing) a produced moving image from a captured image through the network 40. The cloud server 20 is an example of an image processing apparatus to which the present disclosure is applied. The cloud server 20 receives the image captured by the camera 10 via the network 40. The cloud server 20 creates a produced moving image by performing processing such as editing on the captured image, and transmits the produced moving image to the terminal device 30 via the network 40.

The terminal device 30 is a device such as a personal computer (PC), a tablet terminal, or a smartphone. The terminal device 30 performs processing such as setting related to the moving image production service and editing of a produced moving image, in accordance with a user's operation. The terminal device 30 receives the produced moving image transmitted from the cloud server 20 via the network 40. The terminal device 30 records the produced moving image in the terminal, or outputs the produced moving image to the outside.

### <Example Configuration of the Camera>

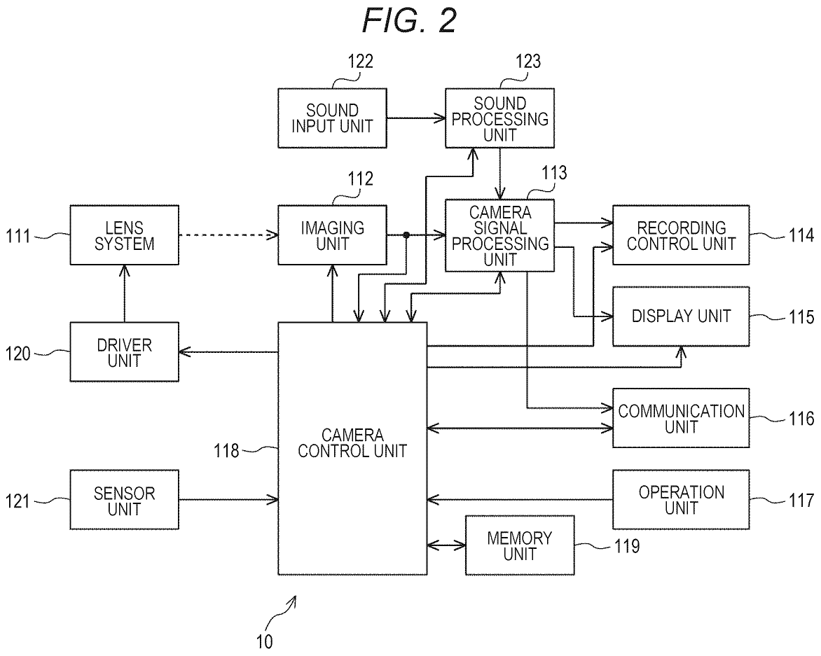

FIG. 2 is a block diagram illustrating an example configuration of the camera 10 shown in FIG. 1.

As illustrated in FIG. 2, the camera 10 includes a lens system 111, an imaging unit 112, a camera signal processing unit 113, a recording control unit 114, a display unit 115, a communication unit 116, an operation unit 117, a camera control unit 118, a memory unit 119, a driver unit 120, a sensor unit 121, a sound input unit 122, and a sound processing unit 123.

The lens system 111 captures incident light (image light) from the object, and causes the incident light to enter the imaging unit 112. The imaging unit 112 includes a solid-state imaging element such as a complementary metal oxide semiconductor (CMOS) image sensor. The imaging unit 112 converts the amount of incident light gathered as an image on the imaging surface of the solid-state imaging element by the lens system 111 into an electrical signal for each pixel, and outputs the electrical signal as a pixel signal.

The camera signal processing unit 113 includes a digital signal processor (DSP), a frame memory that temporarily records image data, and the like. The camera signal processing unit 113 performs various kinds of signal processing on the image signal output from the imaging unit 112, and outputs the resultant image data of the captured image. In this manner, the lens system 111, the imaging unit 112, and the camera signal processing unit 113 constitute an imaging system.

The recording control unit 114 records the image data of the image captured by the imaging system into a storage medium including a memory card such as a flash memory. The display unit 115 includes a liquid crystal display, an organic EL display, or the like, and displays the image captured by the imaging system.

The communication unit 116 includes a communication module or the like compatible with a predetermined communication scheme such as wireless communication including a wireless LAN or cellular communication (the 5th Generation (5G), for example), and transmits the image data of the image captured by the imaging system to other devices including the cloud server 20 via the network 40 or the like. The operation unit 117 includes an operation system such as physical buttons or a touch panel, and issues operation commands for various functions of the camera 10 in accordance with an operation performed by a user.

The camera control unit 118 includes a processor such as a central processing unit (CPU) or a microprocessor, and controls operation of each component of the camera 10. The memory unit 119 records various kinds of data, under the control of the camera control unit 118. The driver unit 120 drives the lens system 111 to realize autofocusing, zooming, and the like, under the control of the camera control unit 118.

The sensor unit 121 performs sensing of space information, time information, and the like, and outputs a sensor signal obtained as a result of the sensing. For example, the sensor unit 121 includes various kinds of sensors such as a gyroscope sensor and an acceleration sensor.

The sound input unit 122 includes a microphone and the like, collects sound such as a user's voice and environmental sounds, and outputs the resultant sound signal. The sound processing unit 123 performs sound signal processing on the sound signal output from the sound input unit 122. The sound signal from the sound processing unit 123 is input to the camera signal processing unit 113, and is processed in synchronization with the image signal under the control of the camera control unit 118, so that the sound signal is recorded as the sound (voice) of the moving image.

### <Example Configuration of the Cloud Server>

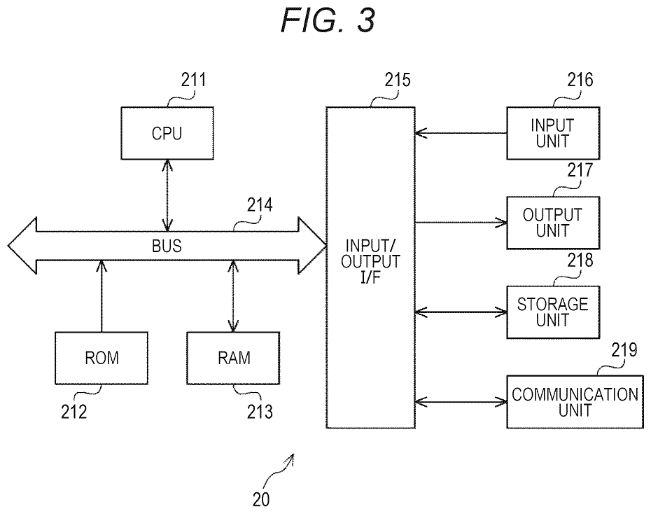

FIG. 3 is a block diagram illustrating an example configuration of the cloud server 20 shown in FIG. 1.

As illustrated in FIG. 3, in the cloud server 20, a CPU 211, a read only memory (ROM) 212, and a random access memory (RAM) 213 are mutually connected by a bus 214. An input/output I/F 215 is further connected to the bus 214. An input unit 216, an output unit 217, a storage unit 218, and a communication unit 219 are connected to the input/output I/F 215.

The input unit 216 supplies various kinds of input signals to each of the components including the CPU 211 via the input/output I/F 215. For example, the input unit 216 includes a keyboard, a mouse, a microphone, and the like.

The output unit 217 outputs various kinds of information via the input/output I/F 215, under the control of the CPU 211. For example, the output unit 217 includes a display, a speaker, and the like.

The storage unit 218 is formed as an auxiliary storage device such as a semiconductor memory or a hard disk drive (HDD). The storage unit 218 records various kinds of data and programs, under the control of the CPU 211. The CPU 211 reads various kinds of data from the storage unit 218 and processes the various kinds of data, or executes a program.

The communication unit 219 includes a communication module or the like compatible with wireless communication such as a wireless LAN or cellular communication (5G, for example), or cable communication. The communication unit 219 communicates with other devices including the camera 10 and the terminal device 30 via the network 40, under the control of the CPU 211.

Note that the configuration of the cloud server 20 illustrated in FIG. 3 is an example, and image processing may be performed by a dedicated processor such as a graphics processing unit (GPU), for example.

### <Example Configuration of the Terminal Device>

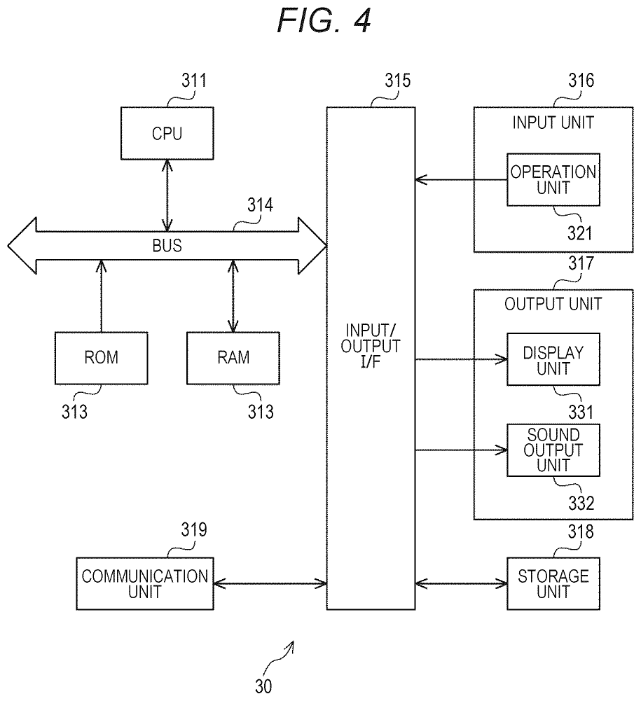

FIG. 4 is a block diagram illustrating an example configuration of the terminal device 30 shown in FIG. 1.

As illustrated in FIG. 4, in the terminal device 30, a CPU 311, a ROM 312, and a RAM 313 are mutually connected by a bus 314. An input/output I/F 315 is further connected to the bus 314. An input unit 316, an output unit 317, a storage unit 318, and a communication unit 319 are connected to the input/output I/F 315.

The input unit 316 supplies various kinds of input signals to each of the components including the CPU 311 via the input/output I/F 315. For example, the input unit 316 includes an operation unit 321. The operation unit 321 includes a keyboard, a mouse, a microphone, physical buttons, a touch panel, or the like. The operation unit 321 is operated by the user, and supplies an operation signal corresponding to the operation to the CPU 311.

The output unit 317 outputs various kinds of information via the input/output I/F 315, under the control of the CPU 311. For example, the output unit 317 includes a display unit 331 and a sound output unit 332.

The display unit 331 includes a liquid crystal display, an organic EL display, or the like. The display unit 331 displays a captured image, an editing screen, or the like, under the control of the CPU 311. The sound output unit 332 includes a speaker, headphones connected to an output terminal, or the like. The sound output unit 332 outputs a sound corresponding to a sound signal, under the control of the CPU 311.

The storage unit 318 is formed as an auxiliary storage device such as a semiconductor memory. The storage unit 318 may be formed as an internal storage, or may be an external storage such as a memory card. The storage unit 318 records various kinds of data and programs, under the control of the CPU 311. The CPU 311 reads various kinds of data from the storage unit 318 and processes the various kinds of data, or executes a program.

The communication unit 319 includes a communication module or the like compatible with a predetermined communication scheme such as wireless communication like a wireless LAN or cellular communication (5G, for example), or cable communication. The communication unit 319 communicates with other devices including the cloud server 20 via the network 40, under the control of the CPU 311.

Note that the configuration of the terminal device 30 illustrated in FIG. 4 is an example, and image processing may be performed by a dedicated processor such as a GPU, for example.

In the moving image production system 1 designed as described above, an image captured by the camera 10 is uploaded to the cloud server 20, and processing such as editing using the captured image is performed by the cloud server 20, so that a produced moving image is produced. The terminal device 30 performs setting, editing, and the like related to the produced moving image, and outputs the completed produced moving image.

Note that, for ease of explanation, the moving image production system 1 in FIG. 1 has a configuration in which one camera 10 and one terminal device 30 are provided as illustrated in the drawing. However, one or a plurality of cameras 10 and one or a plurality of terminal devices 30 are provided for each user who uses the moving image production service. The camera 10 and the terminal device 30 may be operated by the same user, or may be operated by different users. The cloud server 20 is installed in a data center or the like, but is not necessarily formed with one server. The cloud server 20 may include a plurality of servers to provide a moving image production service.

### <Overall Flow>

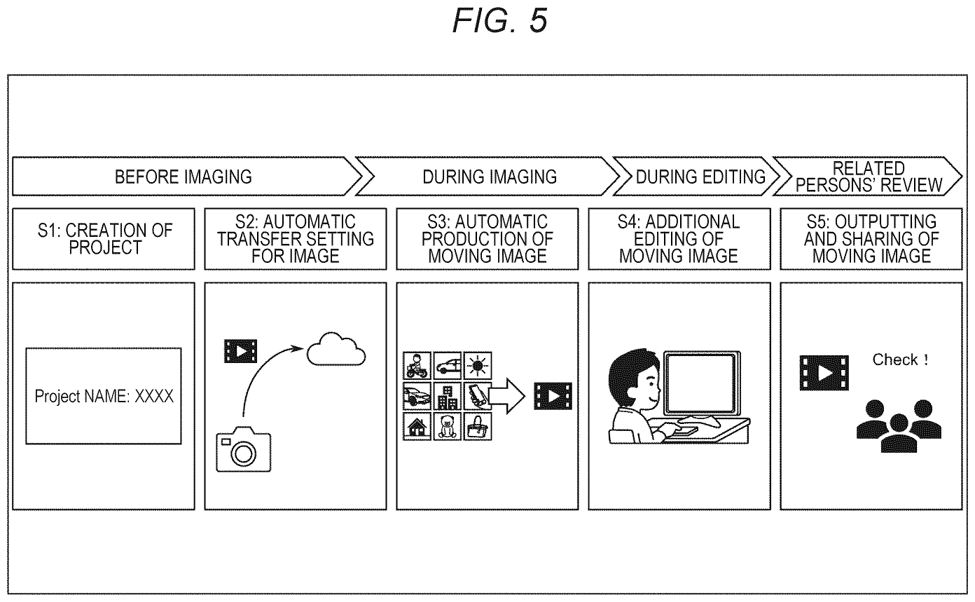

FIG. 5 is a diagram illustrating an overall flow representing the flow in a moving image production service that is provided by the cloud server 20 in the moving image production system 1. The overall flow illustrated in FIG. 5 is divided into before imaging, during imaging, during editing, and a related persons' review, with the direction from the left side toward the right side being the direction of time.

Before the imaging, creation of a project (S1) and automatic transfer setting of a captured image (S2) are performed. In the creation of a project, a project name is input by the user, and a project for managing information regarding creation of a produced moving image is created. In the automatic transfer setting of a captured image, an automatic transfer destination of an image captured by the camera 10 is set. For example, location information (the uniform resource locator (URL) or the like) about the cloud server 20 is set as the automatic transfer destination.

The creation of the project and the automatic transfer setting can be performed from the camera 10 or the terminal device 30 in accordance with a user operation. Alternatively, the setting may be performed from another device such as a smartphone possessed by the user.

During the imaging, a moving image is automatically produced (S3). In the automatic production of a moving image, the cloud server 20 creates a produced moving image, using a captured image transferred from the camera 10. Although details will be described later, in the automatic creation of a moving image, processing such as automatic selection, automatic trimming, and automatic quality correction is performed using a captured image.

During the editing, additional editing (S4) of the moving image is performed. In the additional editing of the moving image, the terminal device 30 additionally edits the produced moving image in accordance with a user operation. This additional editing is not necessarily performed. In a case where the user determines that it is not necessary to edit the produced moving image, it is not necessary to perform additional editing.

In the related persons' review, the moving image is output and shared (S5). In the outputting and sharing of the moving image, the terminal device 30 outputs the produced moving image additionally edited as necessary in a predetermined format, and shares the produced moving image with the related persons. As a result, the produced moving image is reviewed by the related persons, are corrected as appropriate in accordance with the result of the review, and are then delivered.

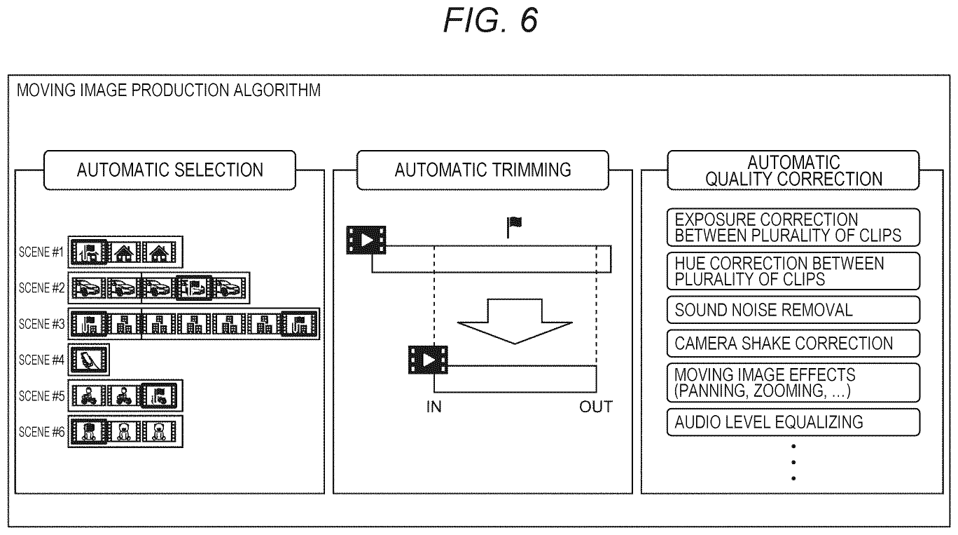

FIG. 6 is a diagram illustrating an example of a moving image production algorithm that is used at the time of moving image production in the automatic production (S3) of the moving image in FIG. 5.

As illustrated in FIG. 6, the moving image production algorithm includes processing such as automatic selection, automatic trimming, and automatic quality correction, and these kinds of processing are performed to create a produced moving image.

In the automatic selection, captured images (clips) including moving images and still images are grouped for each scene (grouping), and an appropriate captured image is selected for each scene. In the automatic trimming, the trimming range of moving images (clips) is designated with an in-point (start point) and an out-point (end point). In a case where a shot mark (the flag in the drawing) depending on an operation by the user is attached to the captured image at a time of imaging, the portions before and after the shot mark are temporally cut off, with the mark serving as the center. Clips are images captured by a device such as the cloud server 20.

In the automatic quality correction, various kinds of corrections are performed on the captured images (clips) to enhance quality. For example, processes such as exposure correction (brightness correction) between a plurality of clips, hue correction (color correction) between the plurality of clips, sound noise removal, camera shake correction, moving image effects such as panning and zooming, and audio level equalizing are performed.

Automatic selection, automatic trimming, and automatic quality correction have been described as an example of the moving image production algorithm herein. However, other processes may be added as long as the processes are necessary in creating a produced moving image.

### <Example of Automatic Quality Correction>

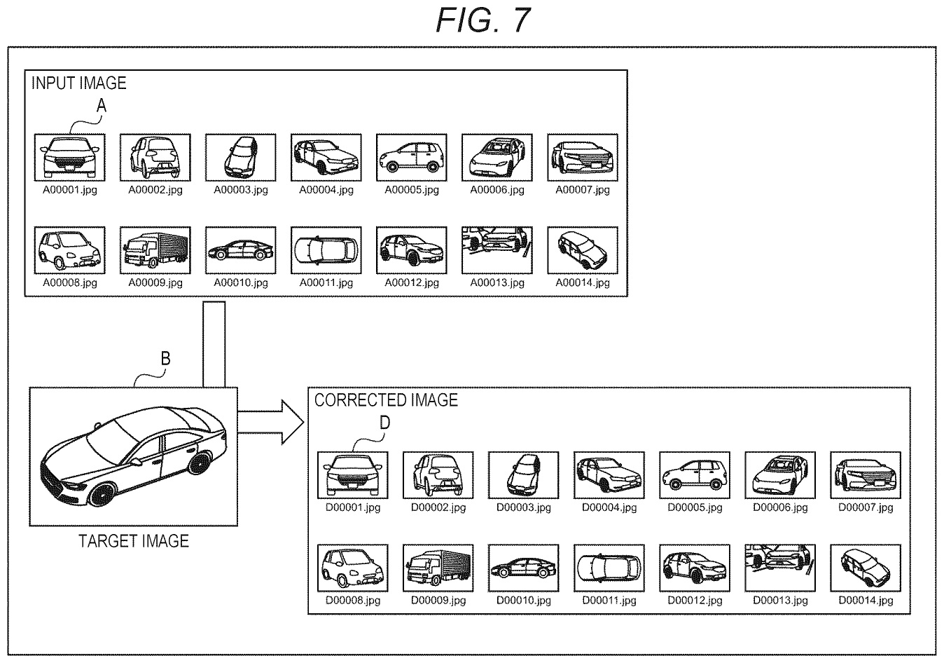

FIG. 7 is a diagram illustrating an example of a correction process to be performed in automatic quality correction. FIG. 7 illustrates an example case where color correction of input images including captured images is performed as a correction process.

As illustrated in FIG. 7, in a correction process to which the present disclosure is applied, when correction (color correction, for example) of an input image A is performed, correction using a target image B to be the target of correction (Exemplar: a target hue) is performed, so that a corrected image D is output. Specifically, in the correction process to which the present disclosure is applied, correction on a pixel basis and correction on an image frame basis are performed on the input image A in two stages.

The input image A is a captured image such as a moving image or a still image captured by the camera 10. The input image A may be a captured image subjected to processing such as automatic selection and automatic trimming. The target image B may be an image captured by the camera 10, or may be an image (an image prepared in advance, for example) other than a captured image.

### <Example of a Functional Configuration>

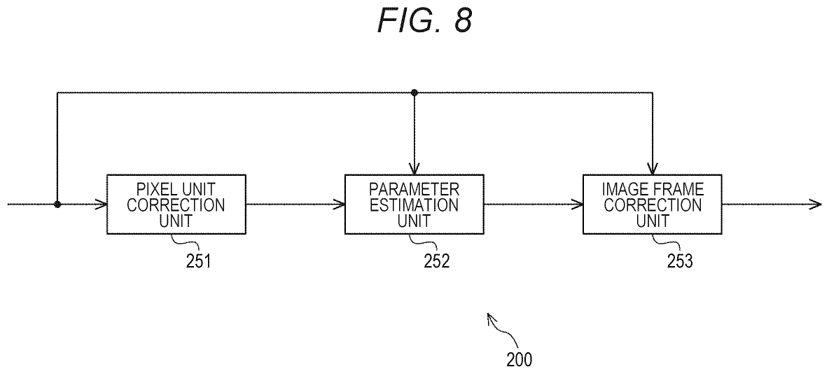

FIG. 8 is a block diagram illustrating an example of the functional configuration of a processing unit 200 in the cloud server 20. The processing unit 200 is formed by a processor such as the CPU 211 or GPU executing a program such as a moving image production program. Alternatively, the processing unit 200 may be formed as a dedicated circuit.

In FIG. 8, the processing unit 200 performs two-stage correction for each first unit and each second unit on the input image A including a captured image. For example, each first unit is a pixel, and each second unit is an image frame. The processing unit 200 includes a pixel unit correction unit 251, a parameter estimation unit 252, and an image frame correction unit 253.

The input image A and the target image B are input to the pixel unit correction unit 251. Using the input image A and the target image B, the pixel unit correction unit 251 performs correction for each pixel, and supplies the resultant intermediate corrected image C to the parameter estimation unit 252. In the correction for each pixel, correction such as color correction and brightness correction is performed on the input image A.

The input image A, or the input image A and the target image B, and the intermediate corrected image C from the pixel unit correction unit 251 are input to the parameter estimation unit 252. Using the input image A and the intermediate corrected image C, the parameter estimation unit 252 estimates an edit parameter P that is a parameter for correction of the entire region (entire image frames) of the input image A, and supplies the edit parameter P to the image frame correction unit 253. Alternatively, the parameter estimation unit 252 estimates the edit parameter P using the input image A, the target image B, and the intermediate corrected image C, and supplies the edit parameter P to the image frame correction unit 253.

The input image A, and the edit parameter P from the parameter estimation unit 252 are input to the image frame correction unit 253. Using the edit parameter P, the image frame correction unit 253 performs correction on the input image A for each image frame, and outputs the resultant corrected image D. In the correction for each image frame, correction such as color correction and brightness correction of the input image A is performed as correction corresponding to the correction for each pixel.

In the processing unit 200 designed as described above, the correction for each pixel by the pixel unit correction unit 251 and the correction for each image frame using the edit parameter P by the image frame correction unit 253 are performed on the input image A, so that correction is performed in two stages. As such two-stage correction is performed, the accuracy of correction on captured images can be increased. For example, as the two-stage correction is performed, correction failures can be reduced, compared with those in a case where only the correction for each pixel in the former stage is performed.

In the description below, the two patterns of a first example and a second example will be described as two-stage correction processes that are performed by the processing unit 200.

### <First Example of a Correction Process>

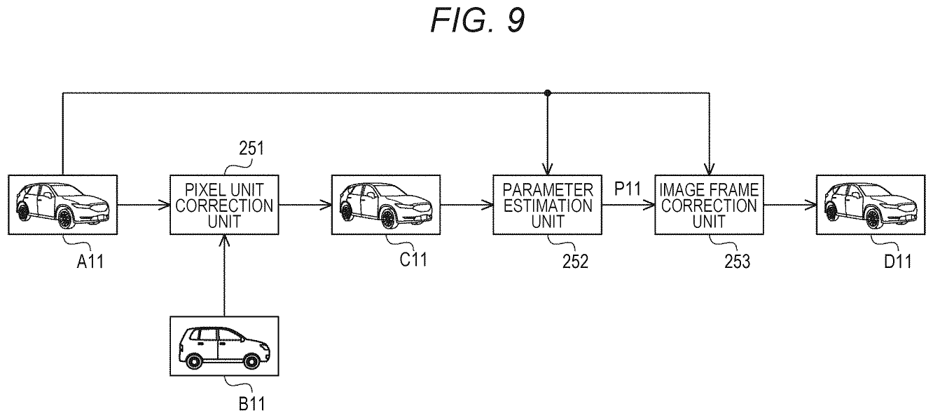

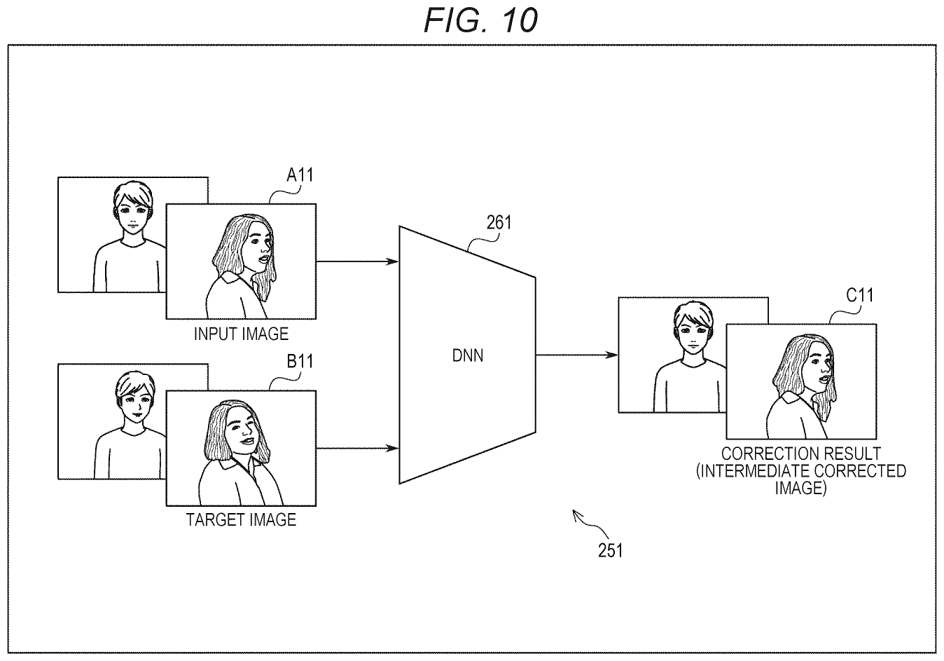

FIG. 9 is a diagram illustrating an outline of the first example of a correction process to be performed by the processing unit 200 illustrated in FIG. 8. In the description with reference to FIG. 9, explanation will be made also with reference to FIGS. 10 to 12 as appropriate.

In the first example of a correction process, two-stage correction is performed on an input image A11 such as a captured image. That is, in the first example of a correction process, an edit parameter P11 is estimated from an intermediate corrected image C11 obtained by correction for each pixel using the input image A11 and a target image B11, and correction for each image frame is performed on the input image A11, using the edit parameter P11. FIG. 9 illustrates an example case where color correction is performed as a correction process on the input image A11 such as a captured image.

The input image A11 and the target image B11 are input to the pixel unit correction unit 251. Using the target image B11, the pixel unit correction unit 251 performs color correction on the input image A11 for each pixel, and supplies the resultant intermediate corrected image C11 to the parameter estimation unit 252.

As illustrated in FIG. 10, a trained model 261 that has been trained by machine learning can be used in the correction process for each pixel. As the input image A11 and the target image B11 are input to the trained model 261, the intermediate corrected image C11 can be obtained as a result of correction of the output.

As the trained model 261, a deep neural network (DNN) that has been trained with input images as training data and a color-corrected image as an output can be used. As such a correction algorithm based on a DNN, a known technique can be used. As color correction using the trained model 261 is performed, the input image A11 can be transformed into the hue of the target image B11.

In the correction process for each pixel, all processes or some processes can be performed with the trained model 261. For example, a combination of a process using the trained model 261, and image processing on the input image A11 and the target image B11 may be performed. Alternatively, in a case where the trained model 261 is not used in the correction process for each pixel, image processing, rule-based processing, or the like may be used.

The input image A11, and the intermediate corrected image C11 from the pixel unit correction unit 251 are input to the parameter estimation unit 252. The parameter estimation unit 252 estimates the edit parameter P11 from the correspondence relationship between the input image A11 and the intermediate corrected image C11, and supplies the edit parameter P11 to the image frame correction unit 253.

The edit parameter P11 is a parameter for correction of the entire region (the entire image frames) of the input image A11. The edit parameter P11 may include a parameter that is used in general image editing software. For example, parameters that are used in image editing processes such as tone curving and level correction can be used.

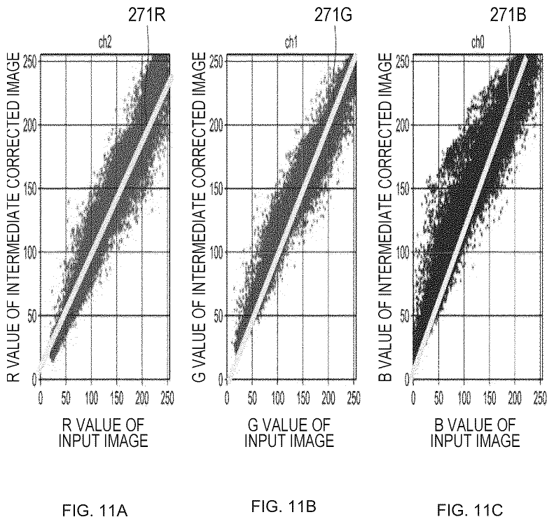

As illustrated in A to C of FIG. 11, when the abscissa axis indicates the RGB values of the input image A11, and the ordinate axis indicates the RGB values of the intermediate corrected image C11, the hue of the entire image frames can be adjusted with tone curves 271R, 271G, and 271B for the respective RGB values. The parameter estimation unit 252 can estimate a parameter related to the adjustment of the hue with the tone curves, as the edit parameter P11.

The input image A11, and the edit parameter P11 from the parameter estimation unit 252 are input to the image frame correction unit 253. Using the edit parameter P11, the image frame correction unit 253 performs color correction on the input image A11 for each image frame, and outputs the resultant corrected image D11.

In this manner, the image frame correction unit 253 uses a parameter (such as a tone curve parameter) compatible with general image editing software as the edit parameter P11, to perform correction again on the input image A11. That is, in the correction process for each pixel, there is a possibility that a portion in which the correction partially fails might appear in an image frame. However, a correction failure can be prevented by correction in two stages including the correction for each pixel using the edit parameter P11.

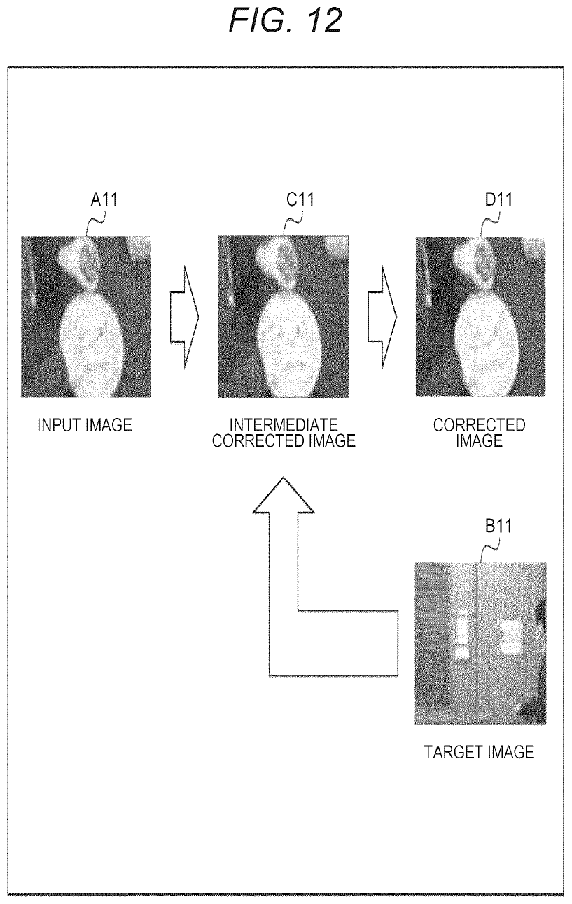

Specifically, as illustrated in FIG. 12, the intermediate corrected image C11 obtained by the correction for each pixel using the input image A11 and the target image B11 appears to have been subjected to appropriate correction as the entire image frames, but the correction fails in a certain portion (the hand portion, for example). Therefore, the input image A11 is corrected for each image frame using the edit parameter P11 in two-stage correction, so that the corrected image D11 in which a correction failure is prevented can be obtained.

Furthermore, since a parameter compatible with general image editing software can be output as the edit parameter P11, the image frame correction unit 253 can perform a correction process not only with specific image editing software but also with image editing software of each company. Further, since the image frame correction unit 253 merely corrects the tone curves with image editing software using the edit parameter P11, it is possible to correct only the hue without causing an overall correction failure.

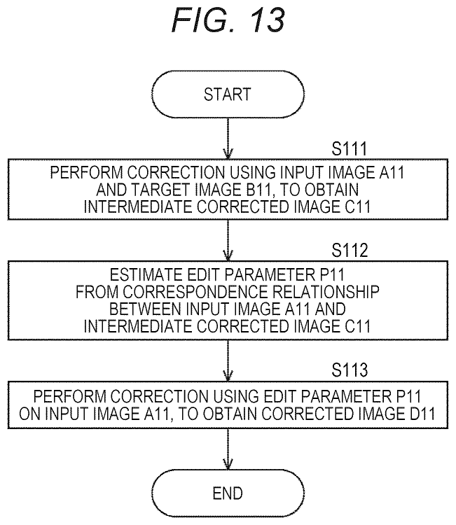

Next, the flow in the first example of the correction process to be performed by the processing unit 200 having the configuration illustrated in FIG. 9 is described with reference to a flowchart shown in FIG. 13.

In step S111, the pixel unit correction unit 251 performs correction (color correction, for example) for each pixel using the input image A11 and the target image B11 input thereto, and obtains the intermediate corrected image C11.

In step S112, the parameter estimation unit 252 estimates the edit parameter P11 from the correspondence relationship between the input image A11 and the intermediate corrected image C11. For example, a tone curve parameter is estimated as the edit parameter P11.

In step S113, the image frame correction unit 253 performs, on the input image A11, correction (color correction, for example) for each image frame using the edit parameter P11, to obtain the corrected image D11.

Here, for example, general image editing software performs a correction process to adjust the hue, using the tone curve parameter as the edit parameter P11. When the process in step S113 is completed, the series of correction processes comes to end.

As described above, in the first example of the correction process, the input image A11 (a captured image or the like) is corrected for each first unit (each pixel) using the target image B11, the edit parameter P11 (a tone curve parameter or the like) is estimated on the basis of the relationship between the input image A11 and the intermediate corrected image C11 obtained from the input image A11 and the target image B11, and the input image A11 (a captured image or the like) is corrected for each second unit (each image frame) using the edit parameter P11. By performing such two-stage correction, it is possible to reduce correction failures, and enhance correction accuracy.

A captured image as the input image A11 has different hues and the like depending on the object, the light situation, and the like at the time of imaging. In the moving image production system 1, to avoid such a state when providing a moving image production service, the first example of a correction process is applied at the point when the captured images to be used in creation of a produced moving image are determined, so that the hues of the captured images to be processed can be made uniform. Thus, it is possible to reduce the sense of discomfort when the user views the produced moving image, and enhance the degree of perfection of the produced moving image. In a case where such a correction process is not automatically performed, a user having knowledge of editing performs the correction process manually, but it takes time and effort. With the correction process, a user having knowledge of editing can save labor by automation, and, on the other hand, a user having no knowledge of editing can perform processes that have not been possible before.

Note that, in the description of the first example of a correction process described above, a case where color correction is performed as the correction process has been explained. However, other correction such as brightness correction may be performed. For example, in a case where brightness correction is performed, a trained model that has been trained to output an image subjected to brightness correction may be used as the trained model 261 in the pixel unit correction unit 251, and a parameter regarding brightness adjustment is only required to be estimated as the edit parameter P11 to be used in the image frame correction unit 253.

### <Second Example of a Correction Process>

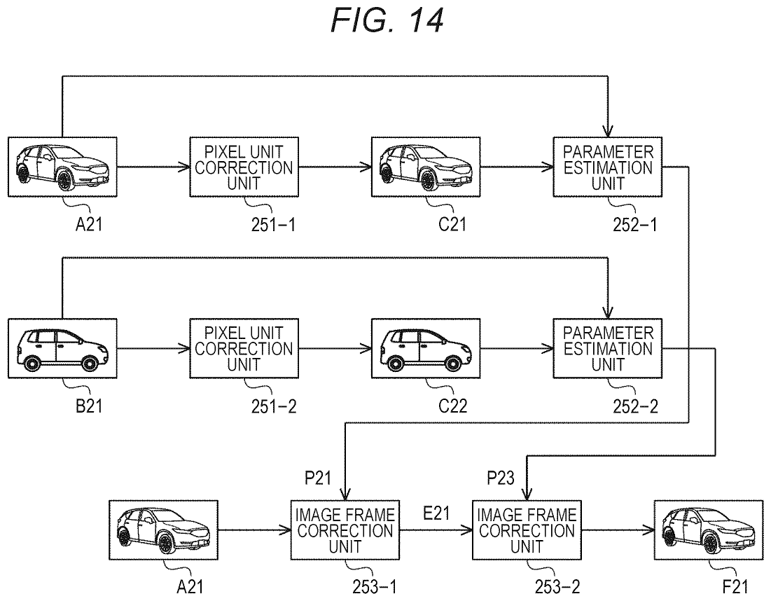

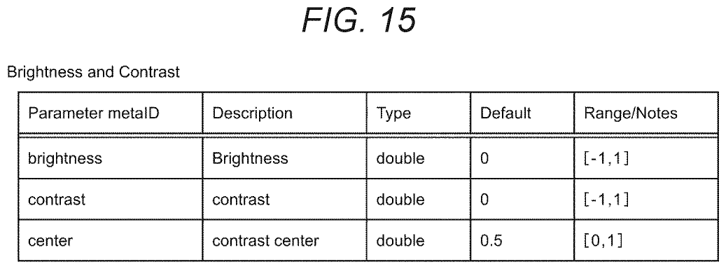

FIG. 14 is a diagram illustrating an outline of the second example of a correction process to be performed by the processing unit 200 illustrated in FIG. 8. In the description with reference to FIG. 14, explanation will be made also with reference to FIGS. 15 to 17 as appropriate.

In the second example of a correction process, two-stage correction is performed on an input image A21 such as a captured image. That is, in the second example of a correction process, edit parameters P21 and P23 are estimated from intermediate corrected images C21 and C21 obtained by correction for each pixel using the input image A21 and a target image B21 separately from each other, and correction for each image frame is performed on the input image A21, using the edit parameters P21 and P23. FIG. 14 illustrates an example case where brightness correction is performed as a correction process on the input image A21 such as a captured image.

A pixel unit correction unit 251-1 performs brightness correction for each pixel on the input image A21 input thereto, and supplies the resultant intermediate corrected image C21 to a parameter estimation unit 252-1.

As the correction process for each pixel, automatic correction such as automatic exposure (AE) correction is performed, for example. In this automatic correction, a trained model that has been trained by machine learning can be used. As the input image A21 is input to the trained model, the intermediate corrected image C21 can be obtained as a result of correction of the output. As the trained model, it is possible to use a DNN that has been trained with an input image as training data and an image subjected to brightness correction as an output. As such a correction algorithm based on a DNN, a known technique can be used.

In the correction process for each pixel, all processes or some processes can be performed with the trained model. For example, a combination of a process using the trained model, and image processing on the input image A21 may be performed. Alternatively, in a case where any trained model is not used in the correction process for each pixel, image processing, rule-based processing, or the like may be used.

The input image A21, and the intermediate corrected image C21 from the pixel unit correction unit 251-1 are input to the parameter estimation unit 252-1. The parameter estimation unit 252-1 estimates the edit parameter P21 from the correspondence relationship between the input image A21 and the intermediate corrected image C21, and supplies the edit parameter P21 to an image frame correction unit 253-1.

The edit parameter P21 is a parameter for correction of the entire region (the entire image frames) of the input image A21. The edit parameter P21 may include a parameter that is used in general image editing software.

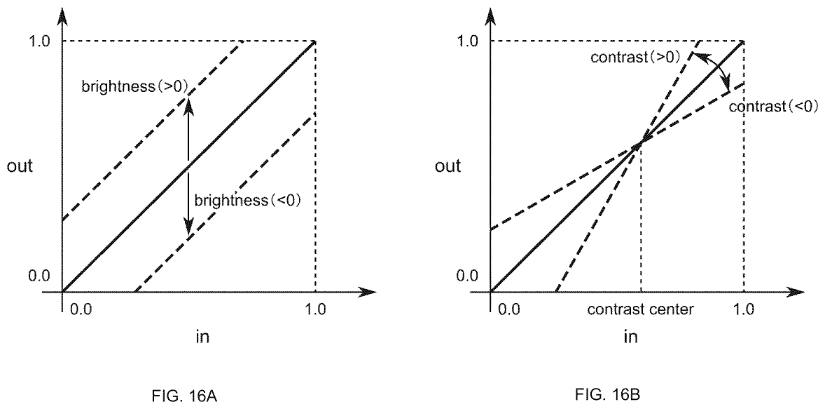

As illustrated in FIG. 15, a parameter for brightness or contrast can be used as the edit parameter P21, for example. In A of FIG. 16, the abscissa axis and the ordinate axis indicate the input and the output, and the fact that the correspondence relationship between the brightness of the input and the brightness of the output can be uniformly adjusted with an offset is indicated by the relationship between a solid line and dashed lines in the graph. In B of FIG. 16, the fact that the inclination of the correspondence relationship between the contrast of the input and the contrast of the output can be adjusted is indicated by the relationship between a solid line and dashed lines in the graph.

A pixel unit correction unit 251-2 performs brightness correction for each pixel on the target image B21 input thereto, and supplies the resultant intermediate corrected image C22 to a parameter estimation unit 252-2. The pixel unit correction unit 251-2 performs a correction process for each pixel similar to that performed by the pixel unit correction unit 251-1.

The target image B21, and the intermediate corrected image C22 from the pixel unit correction unit 251-2 are input to the parameter estimation unit 252-2. The parameter estimation unit 252-2 estimates an edit parameter P22 from the correspondence relationship between the target image B21 and the intermediate corrected image C22. Like the parameter estimation unit 252-1, the parameter estimation unit 252-2 estimates a parameter related to brightness.

Also, the parameter estimation unit 252-2 further estimates the edit parameter P23 for performing correction in the direction opposite to the edit parameter P22, and supplies the edit parameter P23 to an image frame correction unit 253-2.

That is, in the second example of a correction process, an algorithm for performing automatic correction such as AE correction is used in the correction process for each pixel, instead of a correction algorithm for inputting a target value as in the first example of the correction process described above. Therefore, the process is performed on the assumption that the brightnesses of images obtained as a result of automatic correction are substantially the same.

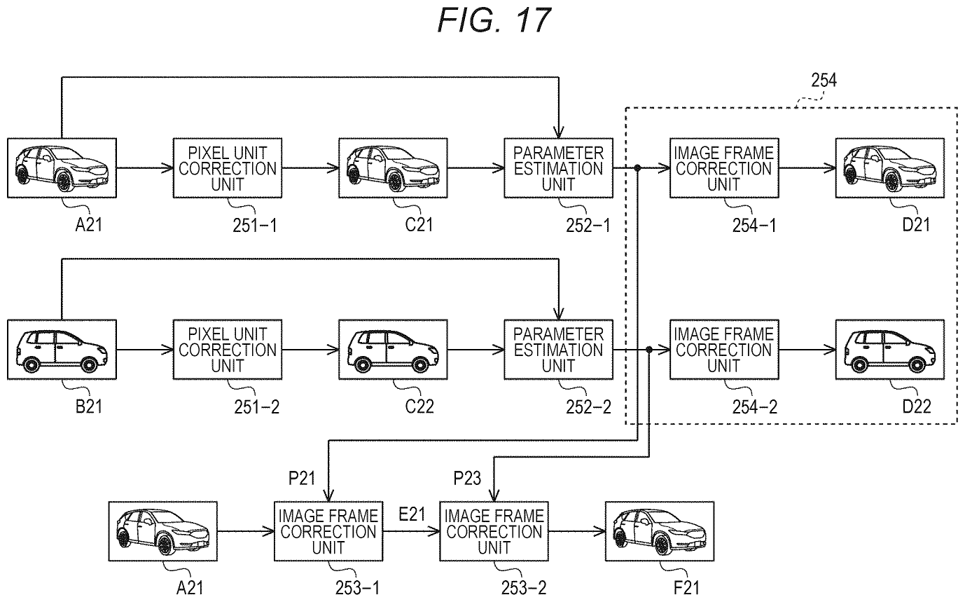

Here, as illustrated in FIG. 17, it is assumed that image frame correction units 254 are provided in a stage subsequent to the parameter estimation units 252-1 and 252-2, and the image frame correction units 254 perform correction using the edit parameters P21 and P22. In an image frame correction unit 254-1, brightness correction using the edit parameter P21 is performed on the input image A21, and a corrected image D21 is obtained. Further, in an image frame correction unit 254-2, brightness correction using the edit parameter P22 is performed, and a corrected image D22 is obtained.

The corrected image D21 and the corrected image D22 obtained by such correction are images having similar brightnesses. Although the correction process by the image frame correction units 254 illustrated in FIG. 17 is not actually performed, the second example of the correction process is performed on the basis of the relationship in which the corrected images D21 and D22 obtained by the correction process have similar brightnesses.

Returning back to FIG. 14, the input image A21, and the edit parameter P21 from the parameter estimation unit 252-1 are input to the image frame correction unit 253-1. The image frame correction unit 253-1 performs brightness correction using the edit parameter P21 on the input image A21, and supplies the resultant corrected image E21 to the image frame correction unit 253-2.

The corrected image E21 from the image frame correction unit 253-1, and the edit parameter P23 from the parameter estimation unit 252-2 are input to the image frame correction unit 253-2. The image frame correction unit 253-2 performs brightness correction (inverse transform) using the edit parameter P23 on the corrected image E21, and outputs the resultant corrected image F21.

As described above, on the premise that the brightnesses of images obtained as a result of automatic correction are substantially the same, after the brightness correction using the edit parameter P21, the brightness correction using the edit parameter P23 is performed to reset (inversely convert) the brightness of the image. Thus, the brightness of the image is made closer to the target value.

In such two-stage correction including the automatic correction and the correction using the edit parameters, the input image A21 is corrected for each image frame using the edit parameters P21 and P23, so that the corrected image F21 in which a correction failure is prevented can be obtained. Furthermore, as the edit parameter P21 and the edit parameter P23, parameters compatible with general image editing software, such as parameters related to brightness, are used. Thus, the image frame correction unit 253-1 and the image frame correction unit 253-2 can perform a correction process with image editing software of each company.

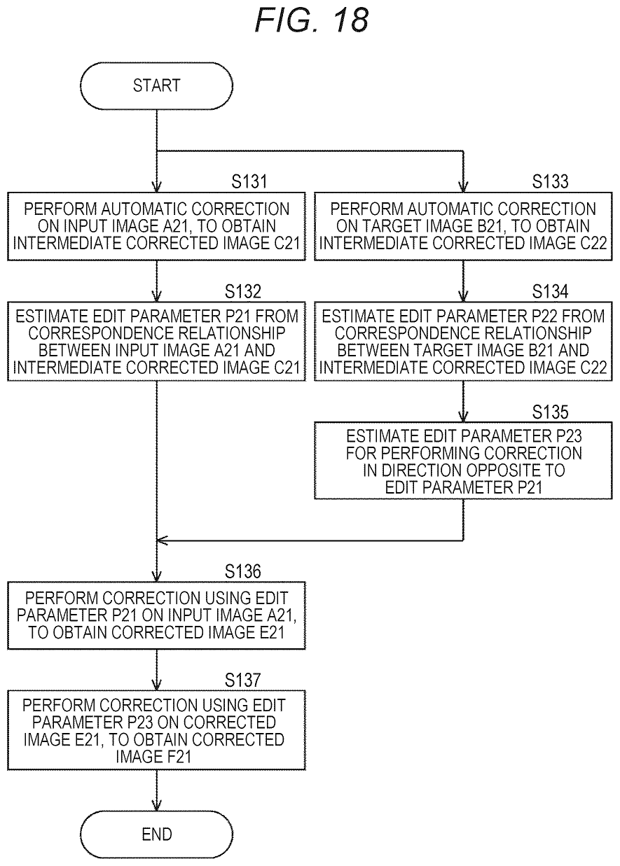

Next, the flow in the second example of the correction process to be performed by the processing unit 200 having the configuration illustrated in FIG. 14 is described with reference to a flowchart shown in FIG. 18.

In step S131, the pixel unit correction unit 251-1 performs automatic correction (brightness correction, for example) such as AE on the input image A21 input thereto, and obtains the intermediate corrected image C21.

In step S132, the parameter estimation unit 252-1 estimates the edit parameter P21 from the correspondence relationship between the input image A21 and the intermediate corrected image C21. For example, as the edit parameter P21, a parameter related to brightness, such as “brightness +0.2”, is estimated.

When the process on the input image A21 in steps S131 and S132 is completed, the process moves on to step S136.

In step S133, the pixel unit correction unit 251-2 performs automatic correction (brightness correction, for example) such as AE on the target image B21 input thereto, and obtains the intermediate corrected image C22.

In step S134, the parameter estimation unit 252-2 estimates the edit parameter P22 from the correspondence relationship between the target image B21 and the intermediate corrected image C22. Also, in step S135, the parameter estimation unit 252-2 estimates the edit parameter P23 for performing correction in the direction opposite to the edit parameter P22.

For example, in a case where a parameter “brightness −0.1” is estimated as the edit parameter P22, a parameter “brightness +0.1” is estimated as the edit parameter P23 for performing correction in the direction opposite to the correction using the edit parameter P22.

When the process on the target image B21 in steps S133 to S135 is completed, the process moves on to step S136. Steps S131 and S132, and steps S133 to S135 can be carried out in parallel.

In step S136, the image frame correction unit 253-1 performs correction (brightness correction, for example) using the edit parameter P21 on the input image A21 input thereto, and obtains the corrected image E21. For example, the input image A21 is corrected with the edit parameter P21, which is “brightness +0.2”, and thus, the corrected image E21 is obtained.

In step S137, the image frame correction unit 253-2 performs correction (brightness correction, for example) using the edit parameter P23 on the corrected image E21, and obtains the corrected image F21. For example, the corrected image E21 is corrected with the edit parameter P23, which is “brightness +0.1”, and thus, the eventual corrected image F21 is obtained. When the process in step S137 is completed, the series of correction processes comes to end.

As described above, in the second example of the correction process, the input image A21 (a captured image or the like) is corrected for each first unit (each pixel), and the edit parameter P21 (a parameter related to brightness or the like) is estimated on the basis of the relationship between the input image A21 and the intermediate corrected image C21 obtained from the input image A21, while the target image B21 is corrected for each first unit (each pixel), and the edit parameter P22 (a parameter related to brightness or the like) is estimated on the basis of the relationship between the target image B21 and the intermediate corrected image C22 obtained from the target image B21. The edit parameter P23 for performing correction in the direction opposite to the correction using the estimated edit parameter P22 is then estimated, and the input image A21 (a captured image or the like) is corrected for each second unit (each image frame) using the estimated edit parameter P21 and edit parameter P23. By performing such two-stage correction, it is possible to reduce correction failures, and enhance correction accuracy.

A captured image as the input image A11 has different brightnesses and the like depending on the object, the light situation, and the like at the time of imaging. In the moving image production system 1, to avoid such a state when providing a moving image production service, the second example of a correction process is applied at the point when the captured images to be used in creation of a produced moving image are determined, so that the brightnesses of the captured images to be processed can be made uniform.

### <Another Configuration in the Second Example of a Correction Process>

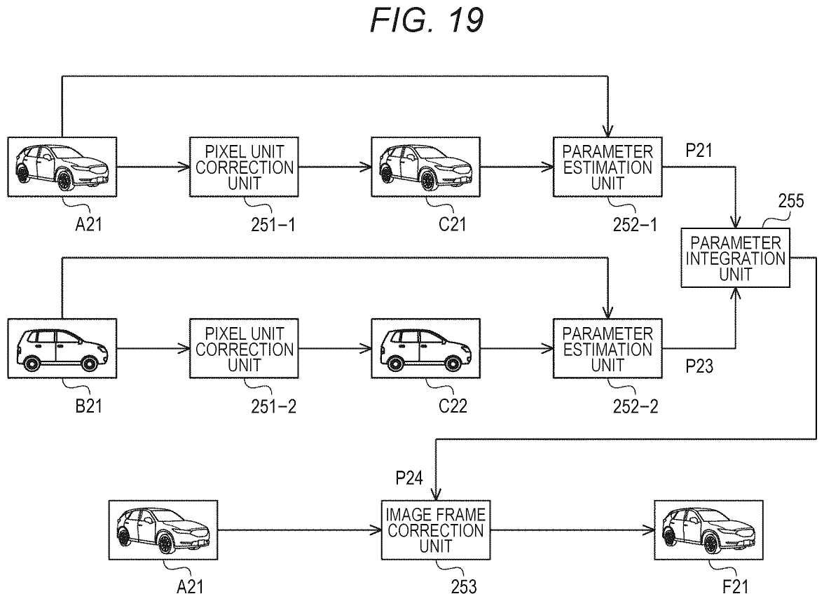

FIG. 19 is a diagram illustrating another example configuration of the processing unit 200 that performs the second example of the correction process.

The configuration illustrated in FIG. 19 differs from the configuration illustrated in FIG. 14 in that a parameter integration unit 255 is provided in a stage subsequent to the parameter estimation unit 252-1 and the parameter estimation unit 252-2.

The parameter integration unit 255 receives the edit parameter P21 from the parameter estimation unit 252-1, and the edit parameter P23 from the parameter estimation unit 252-2.

The edit parameter P21 is the parameter estimated from the correspondence relationship between the input image A21 and the intermediate corrected image C21. The edit parameter P23 is the parameter for performing correction in the direction opposite to the correction using the edit parameter P22 estimated from the correspondence relationship between the target image B21 and the intermediate corrected image C22.

The parameter integration unit 255 estimates an edit parameter P24 by integrating the edit parameter P21 and the edit parameter P23, and supplies the edit parameter P24 to the image frame correction unit 253.

The input image A21, and the edit parameter P24 from the parameter integration unit 255 are input to the image frame correction unit 253. The image frame correction unit 253 performs brightness correction using the edit parameter P24 on the input image A21, and outputs the resultant corrected image F21.

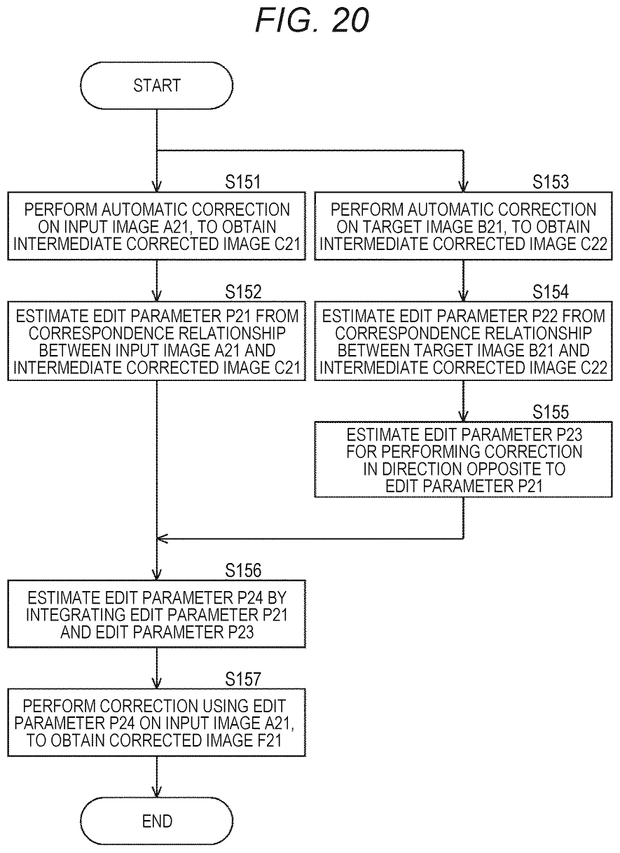

Next, the flow in the second example of the correction process to be performed by the processing unit 200 having the configuration illustrated in FIG. 19 is described with reference to a flowchart shown in FIG. 20.

In steps S151 and S152, the input image A21 is automatically corrected, and the edit parameter P21 is estimated from the correspondence relationship between the input image A21 and the intermediate corrected image C21, as in steps S131 and S132 in FIG. 18.

In steps S153 to S155, the target image B21 is automatically corrected, and the edit parameter P23 for performing correction in the opposite direction of the edit parameter P22 estimated from the correspondence relationship between the target image B21 and the intermediate corrected image C22 is estimated, as in steps S133 to S135 in FIG. 18.

In step S156, the parameter integration unit 255 estimates the edit parameter P24 by integrating the edit parameter P21 and the edit parameter P23. For example, in a case where a parameter “brightness +0.2” is estimated as the edit parameter P21, and a parameter “brightness +0.1” is estimated as the edit parameter P23, these parameters are integrated, to estimate the edit parameter P24, which is “brightness +0.3”.

In step S157, the image frame correction unit 253 performs correction using the edit parameter P24 on the input image A21 input thereto, and obtains the corrected image F21. For example, the input image A21 is corrected with the edit parameter P24, which is “brightness +0.3”, and thus, the eventual corrected image F21 is obtained. When the process in step S157 is completed, the series of correction processes comes to end.

As described above, by performing a correction process using the edit parameter P24 obtained by integrating the two edit parameters P21 and P23, it is possible to integrate correction processes into one, as opposed to the configuration in which a correction process is performed with each of the two edit parameters P21 and P23. Thus, the processing load can be reduced.

Note that, in the description of the second example of a correction process described above, a case where brightness correction is performed as the correction process has been explained. However, other correction such as color correction may be performed. For example, in a case where color correction is performed, automatic correction such as auto white balance (AWB) may be performed as the automatic correction in the pixel unit correction unit 251, and parameters for tone curves or the like are only required to be estimated as the edit parameters P21 to P24.

### <Modifications>

In the above description, the processing unit 200 of the cloud server 20 performs correction processes in the moving image production system 1. However, the processes may be performed by a device other than the cloud server 20. For example, a processing unit of the terminal device 30 may have the functions corresponding to the processing unit 200, to perform all or some of the correction processes.

The process in each step in the flowcharts described above can be performed by hardware, or can be performed software. In a case where the series of processes is performed by software, the program that forms the software is installed into a computer of each device.

The program to be executed by the computer can be recorded in removable recording media as package media or the like to be distributed, for example. Furthermore, the program can be distributed via a wired or wireless transmission medium such as a LAN, the Internet, or digital broadcasting.

In the computer, the program can be installed into a storage unit via an input/output I/F when a removable recording medium is mounted in the drive. Alternatively, the program can be received by a communication unit via a wired or wireless transmission medium, and be installed into a storage unit. In other cases, the program can be installed beforehand into a ROM or a storage unit.

Here, in the present specification, the processes to be performed by the computer in accordance with the program are not necessarily performed on a time-series basis according to the sequences shown in the flowcharts. In other words, the processes to be performed by the computer in accordance with the program include processes to be performed in parallel or independently of one another (parallel processes or object-based processes, for example).

Furthermore, the program may be processed by one computer (processor), or may be subjected to distributed processing by a plurality of computers. Moreover, the program may be transferred to a remote computer, and be executed therein.

Embodiments of the present disclosure are not limited to the above embodiments, and various modifications can be made without departing from the scope of the present disclosure.

In the present specification, the term “automatic” means that a device such as the cloud server 20 performs processing without a direct operation performed by the user, and the term “manual” means that processing is performed via a direct operation performed by the user. Furthermore, the effects described in the present specification are merely examples and are not restrictive, and other effects may be achieved.

In the present specification, a system is intended to mean a set of a plurality of components (devices, modules (parts), or the like), and it does not matter whether or not all the components are disposed in the same housing. Therefore, a plurality of devices housed in separate housings and connected via a network, and a single device with a plurality of modules disposed in one housing are both systems.

Furthermore, the present disclosure can have the following configurations.

(1)

An image processing apparatus including
a processing unit that
corrects a captured image for each first unit,
estimates a parameter for correction of the captured image, on the basis of a relationship between the captured image and an intermediate corrected image obtained by correction for each first unit, and
corrects the captured image for each second unit larger than each first unit, using the estimated parameter.
   (2)

The image processing apparatus of (1), in which
each first unit is a pixel,
each second unit is an image frame, and
the parameter is a parameter for correction of an entire region of the captured image.
   (3)

The image processing apparatus of (2), in which
the processing unit
corrects the captured image for each first unit, using a target image as a target of correction, and
estimates the parameter on the basis of a relationship between the captured image and the intermediate corrected image obtained from the captured image and the target image.
   (4)

The image processing apparatus of (3), in which
the processing unit corrects the captured image for each first unit from the captured image and the target image, using a trained model that has been trained by machine learning.
   (5)

The image processing apparatus of (4), in which
the trained model is a deep neural network (DNN) that has been trained, an input being an image serving as training data, an output being a corrected image.
   (6)

The image processing apparatus of any one of (2) to (5), in which
the processing unit corrects the captured image for each second unit, by image editing software performing a correction process using the parameter.
   (7)

The image processing apparatus of (6), in which
the parameter includes a parameter related to a tone curve.
   (8)

The image processing apparatus of (2), in which
the processing unit
corrects the captured image for each first unit,
estimates a first parameter for correction of the captured image, on the basis of a relationship between the captured image and a first intermediate corrected image obtained by correction of the captured image,
corrects a target image for each first unit, the target image being a target of correction,
estimates a second parameter for correction of the captured image, on the basis of a relationship between the target image and a second intermediate corrected image obtained by correction of the target image,
estimates a third parameter for performing correction in a direction opposite to correction using the estimated second parameter, and
corrects the captured image for each second unit, using the estimated first parameter and third parameter.
   (9)

The image processing apparatus of (8), in which
the processing unit
corrects the captured image for each second unit, using the estimated first parameter, and
corrects the captured image corrected with the first parameter for each second unit, using the estimated third parameter.
   (10)

The image processing apparatus of (8), in which
the processing unit
estimates a fourth parameter by integrating the first parameter and the third parameter, and
corrects the captured image for each second unit, using the estimated fourth parameter.
   (11)

The image processing apparatus of any one of (1) to (10), in which
the processing unit performs correction related to color or brightness of the captured image.
   (12)

The image processing apparatus of any one of (1) to (11),
which is formed as a server that processes the captured image received via a network, the captured image being imaged by a camera that is operated by a user, in which
a moving image produced on the basis of the corrected captured image is transmitted, via a network, to a terminal device that is operated by a user.
   (13)

An image processing method including:
by an image processing apparatus,
correcting a captured image for each first unit;
estimating a parameter for correction of the captured image, on the basis of a relationship between the captured image and an intermediate corrected image obtained by correction for each first unit; and
correcting the captured image for each second unit larger than each first unit, using the estimated parameter.
   (14)

A program for causing a computer to function as
a processing unit that
corrects a captured image for each first unit,
estimates a parameter for correction of the captured image, on the basis of a relationship between the captured image and an intermediate corrected image obtained by correction for each first unit, and
corrects the captured image for each second unit larger than each first unit, using the estimated parameter.

### REFERENCE SIGNS LIST

1 Moving image production system
10 Camera
20 Cloud server
30 Terminal device
40-1, 40-2, 40 Network
200 Processing unit
211 CPU
251, 251-1, 251-2 Pixel unit correction unit
252, 252-1, 252-2 Parameter estimation unit
253, 253-1, 253-2 Image frame correction unit
255 Parameter integration unit

1. An image processing apparatus comprising
a processing unit that
corrects a captured image for each first unit,
estimates a parameter for correction of the captured image, on a basis of a relationship between the captured image and an intermediate corrected image obtained by correction for each first unit, and
corrects the captured image for each second unit larger than each first unit, using the estimated parameter.

2. The image processing apparatus according to claim 1, wherein
each first unit is a pixel,
each second unit is an image frame, and
the parameter includes a parameter for correction of an entire region of the captured image.

3. The image processing apparatus according to claim 2, wherein
the processing unit
corrects the captured image for each first unit, using a target image as a target of correction, and
estimates the parameter on a basis of a relationship between the captured image and the intermediate corrected image obtained from the captured image and the target image.

4. The image processing apparatus according to claim 3, wherein
the processing unit corrects the captured image for each first unit from the captured image and the target image, using a trained model that has been trained by machine learning.

5. The image processing apparatus according to claim 4, wherein
the trained model includes a deep neural network (DNN) that has been trained, an input being an image serving as training data, an output being a corrected image.

6. The image processing apparatus according to claim 2, wherein
the processing unit corrects the captured image for each second unit by image editing software performing a correction process using the parameter.

7. The image processing apparatus according to claim 6, wherein
the parameter includes a parameter related to a tone curve.

8. The image processing apparatus according to claim 2, wherein
the processing unit
corrects the captured image for each first unit,
estimates a first parameter for correction of the captured image, on a basis of a relationship between the captured image and a first intermediate corrected image obtained by correction of the captured image,
corrects a target image for each first unit, the target image being a target of correction,
estimates a second parameter for correction of the captured image, on a basis of a relationship between the target image and a second intermediate corrected image obtained by correction of the target image,
estimates a third parameter for performing correction in a direction opposite to correction using the estimated second parameter, and
corrects the captured image for each second unit, using the estimated first parameter and third parameter.

9. The image processing apparatus according to claim 8, wherein
the processing unit
corrects the captured image for each second unit, using the estimated first parameter, and
corrects the captured image corrected with the first parameter for each second unit, using the estimated third parameter.

10. The image processing apparatus according to claim 8, wherein
the processing unit
estimates a fourth parameter by integrating the first parameter and the third parameter, and
corrects the captured image for each second unit, using the estimated fourth parameter.

11. The image processing apparatus according to claim 1, wherein
the processing unit performs correction related to color or brightness of the captured image.

12. The image processing apparatus according to claim 1,
which is formed as a server that processes the captured image received via a network, the captured image being imaged by a camera that is operated by a user, wherein
a moving image produced on a basis of the corrected captured image is transmitted, via a network, to a terminal device that is operated by a user.

13. An image processing method comprising:
by an image processing apparatus,
correcting a captured image for each first unit;
estimating a parameter for correction of the captured image, on a basis of a relationship between the captured image and an intermediate corrected image obtained by correction for each first unit; and
correcting the captured image for each second unit larger than each first unit, using the estimated parameter.

14. A program for causing a computer to function as
a processing unit that
corrects a captured image for each first unit,
estimates a parameter for correction of the captured image, on a basis of a relationship between the captured image and an intermediate corrected image obtained by correction for each first unit, and
corrects the captured image for each second unit larger than each first unit, using the estimated parameter.
